(19) United States
(12) Patent Application Publication
(10) Pub. No.: US 2012/0155644 A1
(43) Pub. Date: Jun. 21, 2012

(54) METHOD TO MAINTAIN END-TO-END ENCRYPTED CALLS THROUGH A TETRA TMO-DMO GATEWAY WHEN USING SUPER GROUPS

(75) Inventors: MARK J. WEALLEANS, BASINGSTOKE (GB); HUI DIAO, FREDERIKSBERG (DK); KRISTIAN GRONKJAER PEDERSEN, VAERLOSE (DK)

(73) Assignee: MOTOROLA, INC., Schaumburg, IL (US)

(21) Appl. No.: 12/972,987

(22) Filed: Dec. 20, 2010

(51) Int. Cl. H04K 1/00

(52) U.S. Cl. 380/270

(57) ABSTRACT

A method for communicating end-to-end encrypted super group information is provided. Temporary address data, which identifies a temporary address on which the super group is to communicate, is transmitted from a gateway to a back-to-back communications device using a direct mode or data message. The back-to-back communications device retrieves an encryption key associated with the temporary address and uses the encryption key to decrypt super group information sent from a networked communications device on the temporary address. The back-to-back communications reverts back to its original encryption key when super group communications are terminated.

### FIELD OF THE INVENTION

The present invention relates generally to a method to maintain end-to-end encrypted calls in a communications system. In particular, the invention relates to a method to maintain end-to-end encrypted calls through a TErrestrial Trunked Radio (TETRA) gateway when using super groups in a communications system.

### BACKGROUND

Wireless communications devices, such as cellular phones, may use a communications network, such as a cellular network, to route communications from an originating wireless communications device (originating device) to a target wireless communications device (target device). Some wireless communications devices are able to directly communicate with each other without the use of an infrastructure, such as a communications network. Often times, this direct communication is used for short-range ‘push-to-talk’ type communications. Wireless devices that are able to directly communicate with each other without the use of an infrastructure are known herein as back-to-back communications devices and wireless devices that use an infrastructure to communicate with each other are known herein as networked communications devices.

In some communications systems, known herein as mixed-mode communications systems, it is desirable to have both back-to-back communications devices and networked communications devices which are able to communicate with each other through a gateway. In some mixed-mode communications systems, the various wireless communications devices communicate with each other using a communications protocol, such as a TErrestrial Trunked Radio (TETRA) protocol or a Dimetra TETRA protocol. The TETRA protocol was specifically designed for use by government agencies, emergency services, (police forces, fire departments, ambulance), rail transportation staff, transport services and military agencies. The common mode of operation for users of TETRA is in a group calling mode in which a single button push connects a wireless communications device to other wireless communications devices in a selected talk group (also referred to as a group).

Within a mixed-mode communications system, back-to-back communications devices communicate using Direct Mode Operation (DMO) within a DMO Switching and Management Infrastructure (SwMI) and networked communications devices communicate using Trunked Mode Operation (TMO) within a TMO Switching and Management Infrastructure (SwMI). Using DMO allows for using back-to-back communications devices to be used as relays for a communication and also allows for direct communications between a pair of back-to-back communications devices in situations where network coverage is not available. A gateway is used which allows back-to-back communications devices communicating using Direct Mode Operation to receive information from and transmit information to networked communications devices communicating using Trunked Mode Operation by routing information from a TMO address to a DMO address. An address is a specific frequency or channel through which information is routed in a mixed-mode communications system.

For protection against eavesdropping, air interface encryption and end-to-end encryption is available within some mixed-mode communications system. Air interface encryption encrypts information transmitted from an originating device to a communications network. The communications network then decrypts the information and transmits unencrypted information to a target device. End-to-end encryption encrypts information transmitted from an originating device all the way to a target device. In either type of encryption, an encryption key is used in order to decrypt transmitted information. The encryption key used at both the originating device generates the information and encrypts it, along with at the target device or communications network that receives the encrypted information and is to decrypt it.

When information is transmitted using end-to-end encryption to a back-to-back communications device that is connected to the communications network via a gateway, encryption keys are associated with or mapped to specific addresses or channels on which the encrypted information is sent. Each back-to-back and each networked communications device within the mixed-mode communications system includes this mapping, which is used for communications within a group.

Talk groups are groups of a plurality of wireless communications devices any one of which is able to send information received by all wireless communications devices within that group. Each talk group operates on a unique predetermined address, frequency, or channel. As a result, if an originating device is broadcasting encrypted information in a first talk group, the encrypted information is broadcast using a first channel associated with a first encryption key. Any target device that is part of the first talk group receives encrypted information only on the first channel, and therefore is able to decrypt the encrypted information using the first encryption key. Mapping an encryption key to a specific address or channel associated with a talk group allows for information to be transmitted using end-to-end encryption to a back-to-back communications device.

One problem that arises within a mixed-mode communications system occurs when needing to communicate, using end-to-end encryption, between a back-to-back communications device and a networked communications device through a gateway; as the addresses may be different on each side of the gateway. If all addresses are known then encryption keys may be assigned to allow communications to be maintained through the gateway. In some cases, a temporary address is assigned by the network when wireless communications devices are trying to communicate with each other within a super group. A super group is defined as the combination of multiple talk groups, each containing one or more communications devices, that are joined together to form a new group. To form the super group a new group assignment is sent to each group that is to belong to the super group. The assignment contains a new temporary group address. When the super group terminates, the original talk groups once again communicate using the previously assigned addresses. When part of a super group, wireless communications devices can communicate and send information received by all wireless communications devices within that group. Each super group operates on a temporarily assigned address, frequency, or channel and is used when communication between multiple talk groups is desired. However, back-to-back communications devices may be unaware of the temporary address used by the super group, since back-to-back communications devices are not directly connected to the communications network and only receive information retransmitted from the gateway. As a result, when transmitting information using end-to-end encryption to a back-to-back communications device within a super group, the back-to-back communications device is unable to know what temporary channel is being used, and since the information sent is being encrypted, the information cannot be unencrypted.

As a result, it would be desirable within a communications system which includes both back-to-back communications devices and networked communications devices, to send information to and receive information from a back-to-back communications device using end-to-end encryption with a temporary address.

### SUMMARY

In one aspect, a method for transmitting end-to-end encrypted super group information is provided. Temporary address data that identifies a temporary address used for a super group is transmitted from a gateway to a back-to-back communications device. The gateway provides a connection between the back-to-back communications device and a trunked switching and management intrastructure. An encryption key associated with the temporary address is retrieved from storage in the back-to-back communications device. Encrypted super group information is decrypted at the back-to-back communications device using the encryption key retrieved from storage to permit end-to-end encryption of the super group information.

In another aspect, a networked communications device within a TMO Switching and Management Infrastructure initiates a super group communication. The temporary address data is transmitted from the TMO Switching and Management Infrastructure to the gateway and from the gateway to the back-to-back communications device. The back-to-back communications device replaces an original encryption key associated with an address used prior to receiving the temporary address with a super group encryption key associated with the temporary address. The super group information is then communicated between the back-to-back communications device and the networked communications device using the super group encryption key.

The scope of the present invention is defined solely by the appended claims and is not affected by the statements within this summary.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a block schematic diagram of an exemplary computing system, in accordance with one embodiment of the present invention.

FIG. 2 depicts an illustration of a mixed-mode communications system having a back-to-back communications device and a networked communications device which are able to communicate with each other through a gateway, in accordance with one embodiment of the present invention.

FIG. 3 depicts a flowchart illustration of methods, apparatus (systems) and computer program products, in accordance with one embodiment of the present invention.

### DETAILED DESCRIPTION

In the description that follows, the subject matter of the application will be described with reference to acts and symbolic representations of operations that are performed by one or more electronic devices, unless indicated otherwise. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

The present invention makes use of a gateway to transmit temporary address data, which identifies a temporary address on which information is being transmitted by a networked communications device, from the gateway to a back-to-back communications device. Using the temporary address data, the back-to-back communications device is made aware that information is being transmitted by the networked communications device using end-to-end encryption on the temporary address. The back-to-back communications device retrieves an encryption key which is associated with the temporary address using a look-up table and then uses the retrieved encryption key to decrypt the information. As a result, in a communications system which includes both back-to-back communications devices and networked communications devices, information may be sent to or received from a back-to-back communications device using end-to-end encryption with a temporary address.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

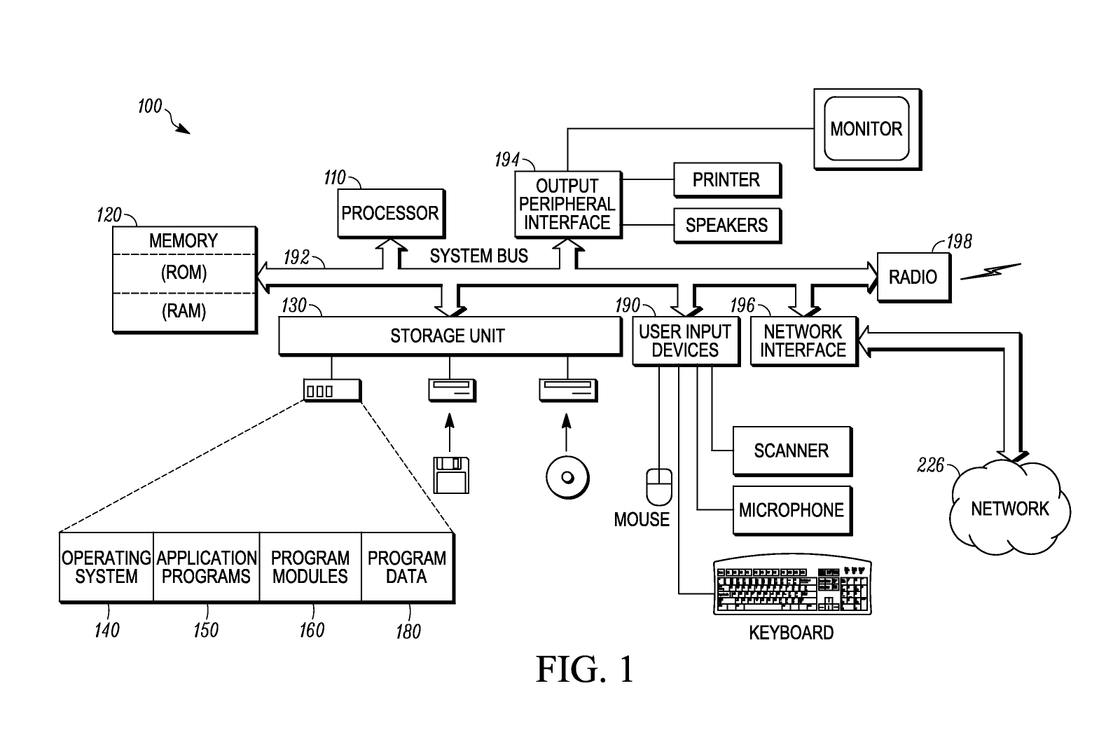

With reference to FIG. 1, depicted is an exemplary communications device 100, which could be any device which can be used to receive, store, process, and transmit information, including devices such as a wireless communications device, a back-to-back communications device, a networked communication device, or a gateway. Communications device 100 may be a portable device, wherein at least some or all of its components are formed together in a single device which can be carried around by a person. The communications device 100 includes a processor 110, memory 120 and one or more storage units 130. The storage units 130 and their associated computer readable memory medium provide storage of computer readable instructions, data structures, program modules and other data for the communications device 100. Storage units 130 can store the contents of an operating system 140, application programs 150, program modules 160, and program data 180. Communications device 100 further includes input devices 190 through which data may enter the communications device 100, either automatically or by a user who enters commands and data. Input devices 190 can include an electronic digitizer, a electronic scanner, a barcode reader, a microphone, a camera, a video camera, a keyboard and a pointing device, a trackball, a touch pad, any USB enabled device, any Bluetooth enabled device, an RFID or NFC device, and a debit card reader. Other input devices may include a joystick, game pad, an antenna, and the like.

These and other input devices 190 can be connected to processor 110 through a user input interface that is coupled to a system bus 192, but may be connected by other interface and bus structures, such as a parallel port, game port or a universal serial bus (USB). Communications device 100 may also include other peripheral output devices such as speakers, a printer, and a display device, which may be connected through an output peripheral interface 194 and the like.

Communications device 100 also includes a radio 198 or other type of communications device for wirelessly transmitting and receiving data for the communications device 100 with the aid of an antenna. Radio 198 may wirelessly transmit and receive data using WiMAX™, 802.11a/b/g/n, Bluetooth™, 2G, 2.5G, 3G, and 4G, LTE, CDMA, TDMA, GSM, and other wireless protocols. Communications device 100 may operate in a networked environment using logical connections to one or more remote communications devices 100.

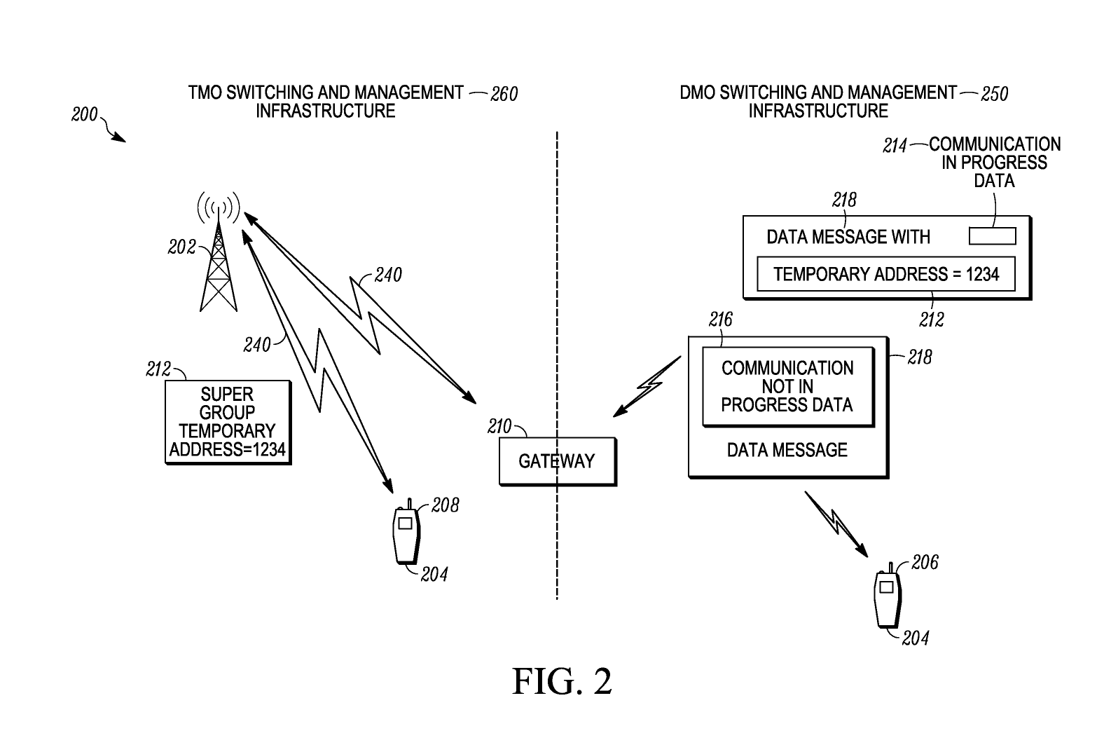

With reference to FIG. 2, depicted is a mixed-mode communications system 200 having a back-to-back communications device 206 and a networked communications device 208 that are able to communicate with each other through a gateway 210. Preferably, the communications system 200 uses a TETRA infrastructure wherein all the communications devices within the communications system 200, such as the back-to-back communications device 206, the networked communications device 208, and the gateway 210, all communicate with each other using a TETRA protocol, such as a Dimetra TETRA protocol. Preferably, communications system 200 is used to connect a variety of wireless communications devices 204, including back-to-back communications devices 206 and networked communications devices 208, to each other allowing for the exchange of information 240 between the wireless communications devices 204. A wireless communications device is any device which can transmit and receive information wirelessly, and includes any device having a radio, a radio receiver, and radio transmitter, or a radio transceiver.

Communications system 200 includes a communications network 202 used to send and receive information 240 between a pair of networked communications devices 208. Communications network 202 is a collection of computers and devices interconnected by communications channels that facilitate communications among users and allows users to share resources. The communications network 202 is directly connected with networked communications devices 208 and helps to facilitate the transfer of information 240 between a pair of networked communications devices 208.

Back-to-back communications device 206 is a wireless communications device able to directly communicate with another wireless communications device without the use of the communications network 202. Oftentimes, this direct communication is used for short-range ‘push-to-talk’ type communications. Back-to-back communications device 206 includes ‘push-to-talk’ type devices, walkie-talkies, and other short range wireless communications devices 204 which transmit information 240 to each other without using communications network 202.

Networked communications device 208 is a wireless communications device that uses communications network 202 in order to communicate with another wireless communications device. As a result, networked communications devices 208 are able to transmit information 240 to and communicate with wireless communications devices 204 for which the trunked mode of operation is desirable, e.g., devices that are far enough from each other to not be able to communicate through direct mode (e.g., greater than several kilometers). Networked communications devices 208 include cellular phones, smart phones, pagers, and other long range wireless communications devices 204 that transmit information 240 to each other using communications network 202.

Back-to-back communications devices 206 communicate using Direct Mode Operation (DMO) within a DMO Switching and Management Infrastructure (SwMI) 250 and networked communications devices 208 communicate using Trunked Mode Operation (TMO) within a TMO Switching and Management Infrastructure 260. The back-to-back communications device 206 is able to communicate with (send information 240 to and receive information 240 from) networked communications device 208 through gateway 210.

Gateway 210 is a network node equipped for interfacing between the DMO Switching and Management Infrastructure 250 and the TMO Switching and Management Infrastructure 260, and between the various protocols used within each infrastructure. Preferably, gateway 210 includes devices such as protocol translators, impedance matching devices, rate converters, fault isolators, or signal translators as necessary to provide system interoperability between the DMO and the TMO Switching and Management Infrastructures 250, 260. Gateway 210 is connected with both the networked communications devices 208 via communications network 202 and the back-to-back communications devices 206. Gateway 210 allows back-to-back communications devices 206 communicating using Direct Mode Operation to receive information 240 from and transmit information 240 to networked communications devices 208 communicating using Trunked Mode Operation by routing information 240 from a TMO address to a DMO address. An address is a specific frequency or channel through which information 240 is routed in mixed-mode communications system 200.

Information 240 includes any type of data which can be sent within a communications system 200, such as text messages, voice or audio messages, pictures, video, text, and any other data which can be transmitted. For protection against eavesdropping, communications system 200 employs air interface encryption and end-to-end encryption to make information 240 unreadable to anyone except those possessing an encryption key. Air interface encryption encrypts information 240 transmitted from any originating wireless communications device to communications network 202. The communications network 202 then decrypts the information 240 and transmits unencrypted information to a target wireless communications device. End-to-end encryption encrypts information 240 transmitted from an originating wireless communications device all the way to a target wireless communications device. In either type of encryption, an encryption key is used to decrypt any information 240 which is transmitted. The encryption key is used at both the originating wireless communications device that generates the information 240 and encrypts it, along with at the target wireless communications device or communications network that receives the encrypted information 240 and to decrypt the information 240.

Communications system 200 allows for communication between a group of wireless communications devices 204 called a talk group. A talk group is a group of a plurality of wireless communications devices 204 any one of which can communicate and send information which is received by all wireless communications devices 204 within that group. Each talk group operates on a unique predetermined address, frequency, or channel. For example, if an originating wireless communications device is broadcasting encrypted information 240 in a first talk group, the encrypted information 240 will be broadcast using a first channel associated with a first encryption key. Any target wireless communications device that is part of the first talk group receives encrypted information only on the first channel associated with the first encryption key, and therefore is able to decrypt the encrypted information using the first encryption key. Mapping an encryption key to a specific address or channel associated with a talk group allows for information to be transmitted using end-to-end encryption to back-to-back communications device 206 within communications system 200.

Communications system 200 also allows for communication between a group of wireless communications devices 204, which form a super group that contains multiple talk groups as defined previously. A super group is assigned to a selected number of wireless communications devices 204, any one of which can communicate and send information received by all wireless communications devices 204 within the super group. As above, each super group operates on a temporarily assigned address, frequency, or channel and is used when communication between multiple talk groups is desired. For example, a first wireless communications device may be in a first talk group communicating with other wireless devices within the first talk group using a first channel, while a second wireless communications device may be in a second talk group communicating with other wireless devices within the second talk group using a second channel. If communication between the first and second talk groups is desired, a super group that encompasses both the first and second talk groups may be formed by the communications system 200. A temporary address or channel is created when using a super group in order for communication between wireless communications devices 204 in the first and second talk groups to take place.

In order for the communications system 200 to transmit information 240 on a temporary address using end-to-end encryption between back-to-back communications device 206 and networked communications 208 when in a super group, the gateway 210 transmits temporary address data 212, which identifies the temporary address, to the back-to-back communications device 206. The temporary address is assigned by the TMO Switching and Management Infrastructure 260. Temporary address data 212 identifies the temporary address by providing an address number, a channel number on which information 240 using the temporary address is transmitted, a frequency number of a frequency at which a channel on which information 240 using the temporary address is transmitted, or other information that can identify the temporary address. The gateway 210, in one embodiment, receives the temporary address data 212 in a TETRA protocol message that includes trunked mode standard identification data.

In one embodiment, the gateway 210 transmits temporary address data 212 to the back-to-back communications device 206 in a data message 218. The data message 218 is any message transmitted by the gateway 210 that includes text, images, video, or other data, such as a text message, an SMS message, an MMS message, or a short data service message (SDS).

In another embodiment, the gateway 210 transmits temporary address data 212 to the back-to-back communications device 206 using a TETRA protocol message. The TETRA protocol message is any message transmitted by the gateway 210 that includes direct mode standard identification data, such as a DM-INFO message sent by the gateway 210 using the TETRA protocol. The DM-INFO message allows for a calling party address to be sent during call set up or periodically during a call. This address can be used to pass the temporary address data 212 to the back-to-back communications device 206 with an additional indication added by the gateway 210 to indicate that this address is a temporary address data 212 rather than the specified calling party address.

In one embodiment, the gateway 210 transmits communication in progress data 214, which indicates that a super group communication is currently in progress on the temporary address, to the back-to-back communications device 206. Preferably, the communication in progress data 214 is periodically transmitted to the back-to-back communications device 206. This allows for the back-to-back communications device 206, which just began communicating, to know that a super group communication is ongoing so that the back-to-back communications device 206 can revert to a previously selected encryption key used for talk group communications once the temporary address has been de-assigned and the super group communication has ended. Thus, the original talk group address (used by the back-to-back communications device 206) is inactivated and original encryption key deselected while a super group communication is ongoing and original talk group address is reactivated and original encryption key reselected after termination of the super group communication.

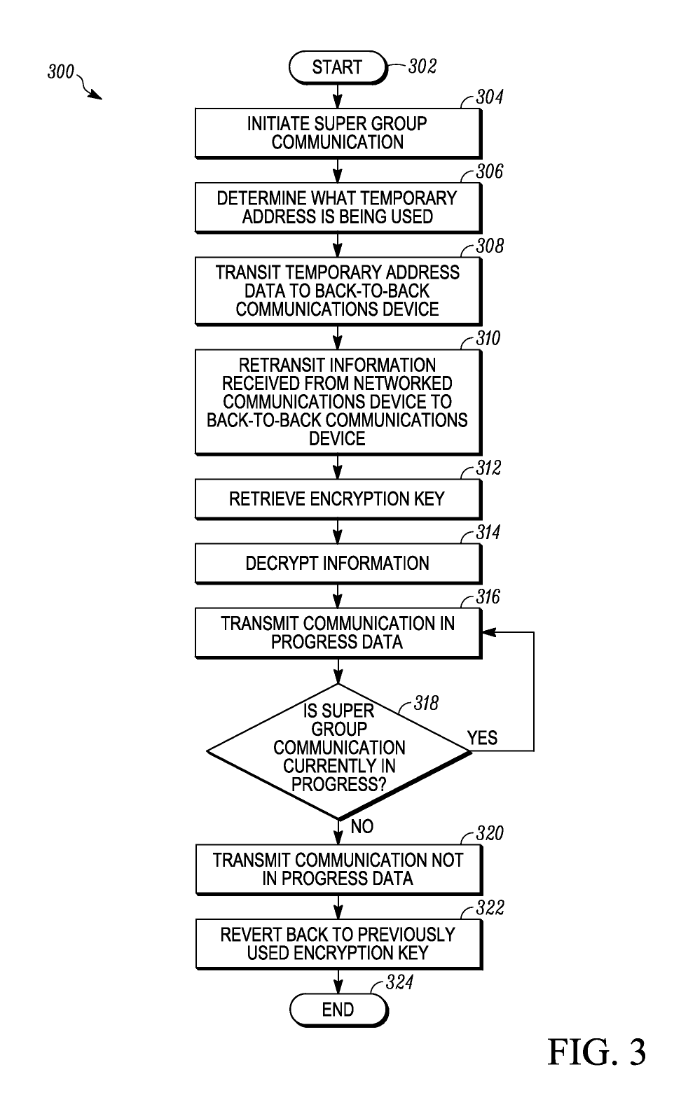

With reference to FIG. 3, in one embodiment, a method 300 for transmitting information 240 to the gateway 210 when using end-to-end encryption is initiated at block 302. Moving to block 304, a super group communication is initiated by a networked communications device within a TMO Switching and Management Infrastructure 260 and a temporary address is created on which information 240 is to be transmitted for conducting the super group communication. The infrastructure 260 sets up the super group communication. To do this, the infrastructure 260 passes the temporary address to all the communications devices within the communications system 200 that are to be part of the super group and therefore receive the super group communication. The communication devices 204 then receive and transmit all information to/from this temporary address until such time as the infrastructure de-assigns the temporary address from the devices.

Upon initiating the super group communication, information 240 is transmitted to networked communications device 208 on the temporary address. The information 240 is, in one embodiment, encrypted by networked communications device 208 so that end-to-end encryption is provided. Moving to block 306, the gateway 210 then determines that a super group communication is in progress and then determines what temporary address is being used by the networked communications device 208 within the TMO Switching and Management Infrastructure 260 to conduct the super group communication. The gateway 210 determines the temporary address being used by receiving temporary address data 212 from the communications network 202, e.g., by receiving information 240 via communications network 202. For example, the gateway 210 determines what temporary address is being used by receiving a Dynamic Group Number Assignment (DGNA) from the communications network 202 for a super group that has been created. The DGNA defines the temporary address data 212 used to communicate between devices.

Upon determining that a super group communication is in progress and what address that communication is using to transmit information 240, the gateway 210 then transmits temporary address data 212, which identifies the temporary address being used, to the back-to-back communications device 206 at block 308. Temporary address data 212 may be transmitted to the back-to-back communications device 206 in a number of ways. In one embodiment, temporary address data 212 is transmitted by a data message 218 which can be sent from the gateway 210 via a text messaging service to any back-to-back communications device 206 connected to the gateway 210 within the DMO Switching and Management Infrastructure 250. In one embodiment, to communicate the temporary address data 212, a unique Protocol Identifier is allocated to the text message to differentiate it from other text messages. For example, a text message may follow an ETSI defined format where a Protocol Identifier precedes the actual text data <protocol identifier><data string>, e.g. <130><sample text>. The Protocol Identifier defines how the following <data string> should be interpreted, e.g. display text on the screen or send the text to a different application. A unique Protocol Identifier can be assigned to indicate the <data string> is in fact a temporary address.

Moving to block 310, after transmitting temporary address data 212 to the back-to-back communications device 206, broadcast information 240 received from the networked communications device 208 by the gateway 210 is re-transmitted to the back-to-back communications devices 206 within the DMO Switching and Management Infrastructure 250. Thus, in one embodiment, information 240, which is end-to-end encrypted, received by the gateway 210 from the network 202 is retransmitted to the back-to-back communications devices 206.

Moving to block 312, upon receiving broadcast information 240 from the gateway 210 at the back-to-back communications device 206, the back-to-back communications device 206 retrieves an encryption key that is associated with the temporary address 212 from information stored within a storage device in the back-to-back communications device 206, such as from a look-up table stored on flash memory in the back-to-back communications device 206. The back-to-back communications device 206 then decrypts broadcast information 240 using the encryption key at block 314.

Moving to block 316, the gateway 210 then transmits communication in progress data 214, which indicates that a super group communication is currently in progress on the temporary address, to the back-to-back communications device 206. Moving to block 318, the gateway 210 then decides whether or not the super group communication is still in progress. If the super group communication is not in progress anymore, then the gateway 210 transmits communication not in progress data 216, which indicates that a super group communication is not currently in progress on the temporary address, to the back-to-back communications device 206, at block 320. For example, communication in progress data 214 or communication not in progress data 216 in the case of a DM-INFO message may follow the format <Information Type><Calling Party TSI> where the <Calling Party TSI> is the address of the calling device. To indicate the <Calling Party TSI> is a temporary address the <Information Type> set to a unique value. This indicates a super group communication is in progress. The value will be reset once the super group communication is finished and not in progress. In the <Protocol Identifier> scenario a text message will be sent when the super group communication is set up and released.

A gateway 210 may determine that a super group communication is not currently in progress by receiving an indication from the communications network 202, such as a Dynamic Group Number Assignment (DGNA) de-assignment of the temporary address data 212 for the super group communication.

Upon receiving the communication not in progress data 216, at block 322 the back-to-back communications device 206 stops using the encryption key allocated for temporary address 212 and reverts back to the previously used encryption key for the previous talk group communication which had been ongoing, and the method 300 ends at block 324. However, if the super group communication is still currently in progress, then the method 300 moves back to block 316.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a computer readable memory medium such as a magnetic medium like a floppy disk, a hard disk drive, and magnetic tape; an optical medium like a Compact Disc (CD), a Digital Video Disk (DVD), and a Blu-ray Disc; computer memory like random access memory (RAM), flash memory, and read only memory (ROM); and a transmission type medium such as a digital and/or an analog communication medium like a fiber optic cable, a waveguide, a wired communications link, and a wireless communication link.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. Accordingly, the invention is not to be restricted except in light of the appended claims and their equivalents.

We claim:

1. A method for transmitting end-to-end encrypted super group information, the method comprising:
transmitting temporary address data, which identifies a temporary address used for a super group, from a gateway to a back-to-back communications device, the gateway providing a connection between the back-to-back communications device and a trunked switching and management intrastructure;
retrieving from storage in the back-to-back communications device an encryption key associated with the temporary address; and
decrypting encrypted super group information at the back-to-back communications device using the encryption key retrieved from storage to permit end-to-end encryption of the super group information.

2. The method of claim 1, wherein the temporary address data is transmitted in a data message.

3. The method of claim 2, wherein the data message is a text message.

4. The method of claim 3, wherein a unique protocol identifier is allocated to the text message to indicate a data string following the protocol identifier is the temporary address and thereby differentiate the text message from other text messages.

5. The method of claim 1, wherein the use of the temporary address is detected by a gateway in a TETRA protocol message that includes trunked mode standard identification data.

6. The method of claim 1 further comprising receiving at the gateway the temporary address data from the trunked switching and management infrastructure.

7. The method of claim 1 further comprising using a TETRA protocol message that includes direct mode standard identification data to transmit the temporary address used for the super group information to the back-to-back communications device.

8. The method of claim 1 further comprising retransmitting from the gateway the end-to-end encrypted information on the temporary address only after transmitting the temporary address data.

9. The method of claim 1 wherein the encryption key associated with the temporary address replaces an encryption key associated with an original talk group address used by the back-to-back communications device to provide end-to-end encryption through the gateway, the back-to-back communications reverting back to the original encryption key after termination of the super group information.

10. The method of claim 9 further comprising the gateway transmitting to the back-to-back communications device communication in progress data periodically while a super group communication is in progress and communication not in progress data to indicate termination of the super group communication.

11. The method of claim 12 wherein the communication in progress data and the communication not in progress data are DM-INFO messages in which an Information Type field is set to a unique value to indicate super group communication is in progress and is reset once the super group communication is not in progress.

13. A method for transmitting super group information, the method comprising:
a networked communications device within a TMO Switching and Management Infrastructure initiating a super group communication;
transmitting temporary address data, which identifies a temporary address used for the super group communication, from the TMO Switching and Management Infrastructure to a gateway to the TMO Switching and Management Infrastructure;
transmitting the temporary address data from the gateway to a back-to-back communications device;
replacing, by the back-to-back communications device, an original encryption key associated with an address used prior to receiving the temporary address with a super group encryption key associated with the temporary address; and
communicating, between the back-to-back communications device and the networked communications device, super group information using the super group encryption key.

14. The method of claim 12 further comprising retransmitting the encrypted super group information from the gateway only after transmitting the temporary address data.

15. The method of claim 12 further comprising the back-to-back communications device and the networked communications device receiving communication in progress data periodically while a super group communication is in progress and communication not in progress data to indicate termination of the super group communication.
